(19) United States
(12) Patent Application Publication
(10) Pub. No.: US 2022/0140674 A1
(43) Pub. Date: May 5, 2022

(54) PORTABLE ELECTROMAGNETIC INDUCTION ELECTRICITY GENERATOR FOR MOBILE CHARGING

(71) Applicant: Eli Winston Silvert, Brighton, MA (US)

(72) Inventor: Eli Winston Silvert, Brighton, MA (US)

(21) Appl. No.: 17/516,641

(22) Filed: Nov. 1, 2021

Related U.S. Application Data
(60) Provisional application No. 63/108,382, filed on Nov. 1, 2020.

(51) Int. Cl. H02K 1/27; H02J 7/14; H02K 1/12

(52) U.S. Cl. CPC H02K 1/27; H02K 1/12; H02J 7/14

(57) ABSTRACT

An electromagnetic induction generator for use in applications where other energy sources are unavailable or undesired includes: a rotor having at least a pair of through holes in its body, the rotor body supporting two or more magnets; a stator including a plurality of conductive windings and a through hole; and a length of filament inserted through the through holes of the rotor and stator, the filament supporting the rotor during use.

Voltage is induced by causing relative rotation between the stator and rotor to create an electrical current that can be stored in an electricity storage unit. During use the stator is held stationary, for example by a mounting member. The rotor is rotated by winding the filament upon itself and then unwinding the filament by applying an input force on either end to induce rotation of the rotor in a manner similar to a traditional button spinner toy.

### CROSS-REFERENCE TO RELATED APPLICATIONS

This application claims the benefit of priority to U.S. Provisional Patent Application No. 63/108,382, filed Nov. 1, 2020 and entitled “An electromagnetic induction electricity generator built on the classic button spinner device,” the entire contents of the application being incorporated herein by reference in its entirety.

### TECHNICAL FIELD

The present disclosure relates generally to a portable device to generate electricity through cyclic translational motion. More particularly, but not exclusively, to a portable device that through axial electromagnetic induction harnesses energy from cyclical motions.

### BACKGROUND

The button spinner, also known as a “buzzer,” “whirligig,” and “button-on-a-string,” is a 5,000-year-old toy that can be easily made by threading a string through two holes of a button and tying their ends together to form a loop. The user can then wind up the string loop by holding the loop at opposite ends with the button in the middle and moving their hands in a circular motion. When the operator pulls on either end of the string loop, the string unwinds and the button can spin very fast. A conventional button spinner is illustrated in FIG. 1.

An estimated 180,000 people in the U.S. and two billion people globally live without consistent access to electricity in their homes. Moreover, an incalculable number of people find themselves temporarily off-grid for a variety of reasons. Consumer electronics are highly relied upon today and are a primary manner of communication and information gathering. Keeping these electronic devices charged, especially in emergency situations or when traveling or living in remote areas, is an un-met need. While large, expensive standalone electricity generators, such as solar panels and wind turbines, have the potential to electrify off-grid homes, they do not meet the needs of those who seek access to electricity when on-the-go. Additionally, these types of standalone generators may not be accessible to communities that lack economic power to install them.

There are several devices known for charging batteries of electronic portable instruments such as a smart phone. Such devices generally serve as a back-up charging device when no electrical outlet is available. The most common conventional portable energy generators are hand-crank generators and portable solar chargers. Both types of generators are often configured to channel energy into a power bank. A charger can be plugged into the power bank to provide electricity into a consumer electronic of choice.

Hand crank power generators are often supplied and marketed as emergency or first response devices for charging small electric-powered devices. These devices are usually equipped with an external crank handle, allowing a user to rotate the handle to generate electricity, either to power the device directly or to charge a rechargeable battery that serves as the direct power source. In such devices a rotor/stator assembly is manually driven by using a connected crank handle to generate electricity. While useful, hand-crank devices also can be physically challenging and time consuming to operate. For example, many hand crank rotary handles are short and difficult to grab. Hand-crank generators can have significant power output, up to 30 W if the person can crank hard enough, but the rotations require significant force that must be exerted manually by the user. As a result, a 30 W power output is not sustainable, as the rotational motion required from the user's arm is exhausting. For many users these devices produce only a minimum amount of energy before the user becomes too tired to continue. In addition, the crank chargers are relatively heavy, generally 5 lbs. or greater, and can also be costly. Examples of such devices include those described in U.S. Pat. Nos. 7,019,492, 7,239,237, 7,049,708, 9,362,852.

Portable solar chargers must balance size with power output and require direct sunlight for power production. For example, a solar charger that is easily portable can only generate 3 W in maximum sunlight and is rather expensive, typically costing $50 or more. These solar chargers can also be unreliable as they are easily broken.

There are also application-specific generators, such as shaker flashlights. The shortcoming of these lies in the name: they generate electricity only for a single application, i.e., lighting. Other power banks with larger storage capacities have proportionately larger price, size, and weight, indicating the impracticality for long off-grid experiences powered by power banks alone.

The Department of Defense in 2019 expressed the need for power generation for individual soldiers on SBIR.gov Topic #A19-133 finding that; “Currently, the individual Soldier's mobility is constrained, in part, by the necessity to carry extra batteries and/or man-portable power generation and battery charging equipment, to meet the power demands of the equipment he/she carries.”

### SUMMARY

There exists an unmet need for a low-cost, portable electricity generator that can be reliably and readily utilized by individuals who travel or live in remote areas, those facing temporary power outages, troops deployed on missions, those living off the grid, or any situation where electrical energy is not reliably and readily available. The present disclosure provides a device having a simple structure that is easy to use with little exertion, which can be used at any time to generate energy for the charging of electronic devices. Contrary to prior art devices, the present device is light-weight at around approximately 2-3 pounds, fully portable, and can produce about 30 Watts of power without causing undue stress to the user.

The electromagnetic induction electricity generator according to the present disclosure includes a rotor including at least a pair of through holes disposed symmetrically and proximal to a central axis of rotation of the disc, and two or more magnets supported radially outward from the center of the disc, a stationary stator including a plurality of windings made from conductive metal and a through hole, and a length of filament inserted through the holes of the rotor and stator, the filament supporting the rotor during use and including opposing ends for grasping. The filament is strung through the holes and may be tied in a loop, making the classic “button-on-a-string” design. The stator also includes a circuit that connects the windings to an electricity storage unit.

The voltage is induced during use by relative rotation between the stator and the rotor to create an electrical current that is then stored in the electricity storage unit. In order to ensure that relative motion is induced during use, the stator is held stationary and may be supported by a mounting member that is secured to a stationary support in one embodiment. The rotation of the rotor is created by use of the length of filament inserted through the holes of the rotor and stator applied by the user at either end of the length of filament. Namely, by winding and then unwinding the length of filament in order to induce rotation of the rotor in the manner done with the traditional button spinner toy.

In one exemplary embodiment, one terminal of the windings is connected to a common floating node (making a wye-connected system), and the other terminal of the windings go to a bridge, where the alternating current is rectified. The voltage is made steadier through an operation cycle with the use of capacitors, and the voltage is precisely controlled with a voltage regulator prior to entering a lithium-ion battery.

As will be appreciated, the device disclosed herein includes few parts, is modular and easily transported because of its small footprint and low weight and can be operated repeatedly without strain on the user. The present device allows the device to be readily and reliably used by people who are permanently or temporarily off-grid to generate and store electricity, which can be used to charge an array of increasingly important electronic devices.

### BRIEF DESCRIPTION OF THE DRAWINGS

Various aspects of at least one embodiment are discussed below with reference to the accompanying figures, which are not necessarily drawn to scale, emphasis instead being placed upon illustrating the principles disclosed herein. The figures are included to provide an illustration and a further understanding of the various aspects and embodiments and are incorporated in and constitute a part of this specification but are not intended as a definition of the limits of any particular embodiment. The figures, together with the remainder of the specification, serve only to explain principles and operations of the described and claimed aspects and embodiments, but are not to be construed as limiting embodiments. In the figures, each identical or nearly identical component that is illustrated in various figures is represented by a like numeral. For purposes of clarity, not every component may be labeled in every figure.

FIG. 1 is a prior art perspective view of a button-spinner toy;

FIG. 2A is a front side perspective view of a rotational electromagnetic induction electricity generator in accordance with a first embodiment of the present disclosure in an unwound state;

FIG. 2B is front side perspective view of the rotational electromagnetic induction electricity generator of FIG. 2B in a wound state;

FIG. 3 is a front side perspective view of the generator of FIG. 2A without the windable filament;

FIG. 4 is a side plan view of the generator of FIG. 3;

FIG. 5 is a rear side perspective view of the generator of FIG. 3;

FIG. 6 is a front exploded view of the generator of FIG. 3;

FIG. 7 is a rear exploded view of the generator of FIG. 3;

FIG. 8 is a bottom plan view of the rotor of the generator of FIG. 3;

FIG. 9 is a bottom perspective view of the rotor of FIG. 8;

FIG. 10 is a top plan view of the stator of the generator of FIG. 3;

FIG. 11 is a top perspective view of the stator of FIG. 10; and

FIG. 12 is a diagram of the circuit connecting the windings to the electric storage device.

### DETAILED DESCRIPTION OF THE ILLUSTRATIVE EMBODIMENTS

The examples of the apparatus and method discussed herein are not limited in application to the details of construction and the arrangement of components set forth in the following description or illustrated in the accompanying drawings. It will be understood to one of skill in the art that the apparatus is capable of implementation in other embodiments and of being practiced or carried out in various ways. Examples of specific embodiments are provided herein for illustrative purposes only and are not intended to be limiting. Also, the phraseology and terminology used herein is for the purpose of description and should not be regarded as limiting. Any references to examples, embodiments, components, elements or acts of the apparatus and method herein referred to in the singular may also embrace embodiments including a plurality, and any references in plural to any embodiment, component, element or act herein may also embrace embodiments including only a singularity (or unitary structure). For example, in one embodiment the through holes for receiving the length of filament include two sets, or four through holes. However, the application is not so limited and other number of holes, such as one set, are also within the scope of the disclosure. References in the singular or plural form are not intended to limit the presently disclosed apparatus, its components, acts, or elements. As used herein, the singular forms “a” “an” and “the” are intended to include the plural forms as well, unless the context clearly indicates otherwise. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

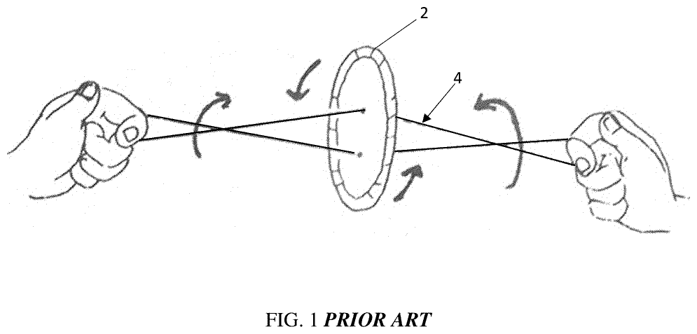

FIG. 1 illustrates a conventional button spinner toy including a button 2 and a length of looped string 4 disposed therethrough for gripping by the user. This figure is used for reference purposes only as to the prior art toy.

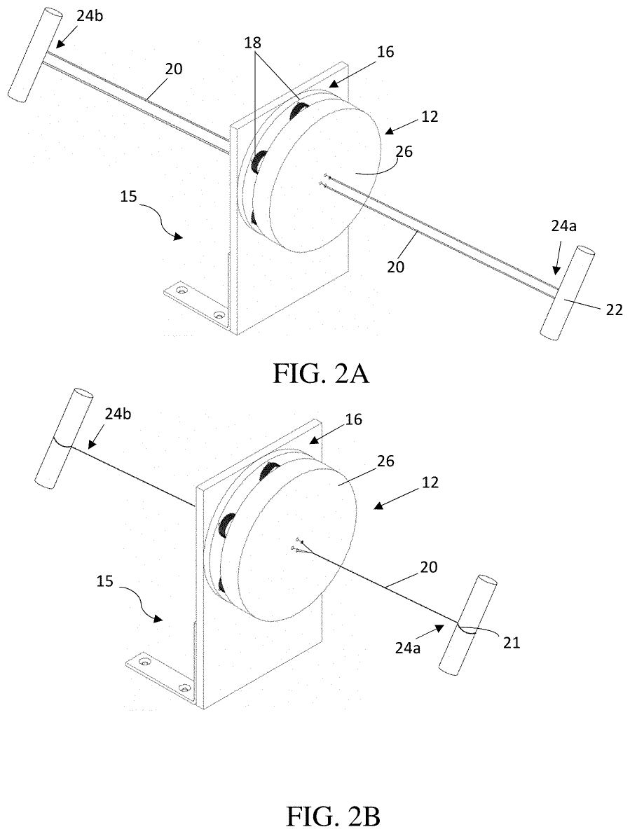

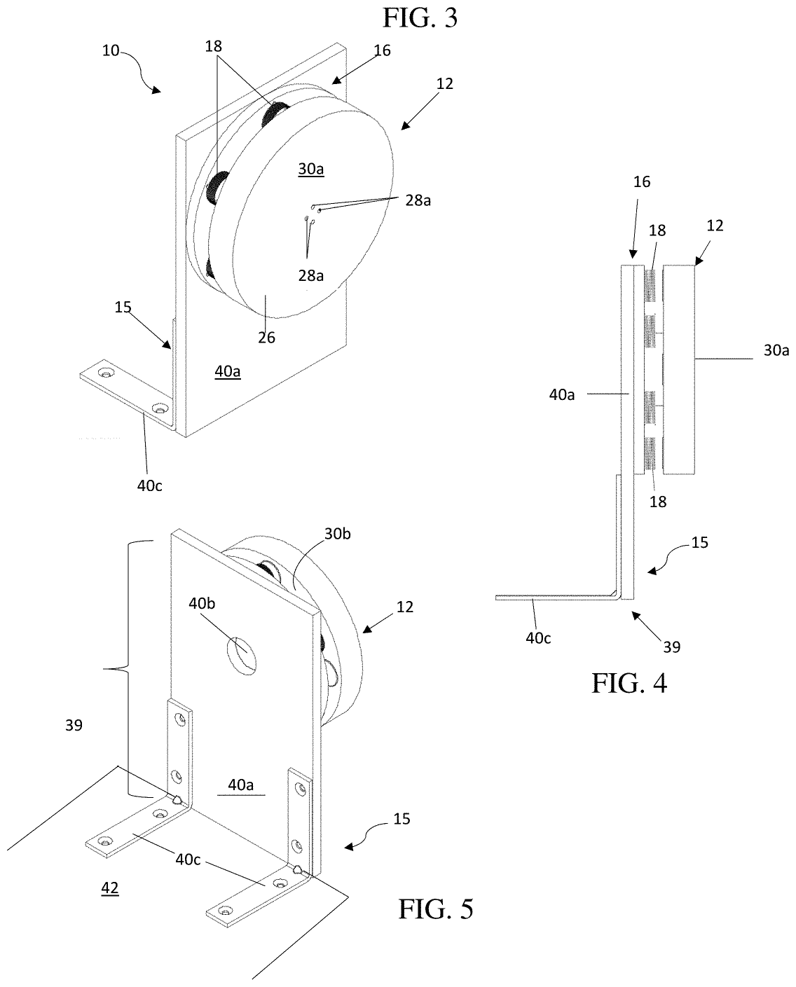

Referring now to FIGS. 2A-7, an electromagnetic induction electricity generator 10 is illustrated according to an exemplary embodiment and includes a disc-shaped rotor 12, two or more magnets 14 supported by the rotor 12, a stationary structure 15 including stator 16 having a plurality of windings 18 made from conductive metal, a length of filament 20 inserted through the holes 28a of the rotor 12 and the stator 16, which support the rotor during use and includes loops 21 or handles 22 at opposing ends 24a, 24b of the length of filament 20.

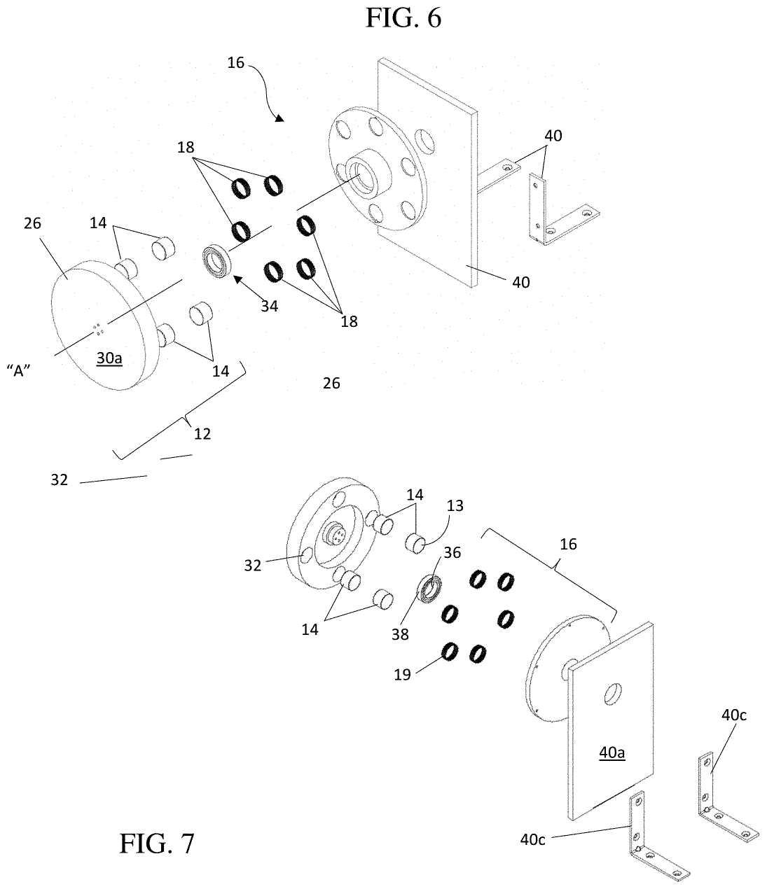

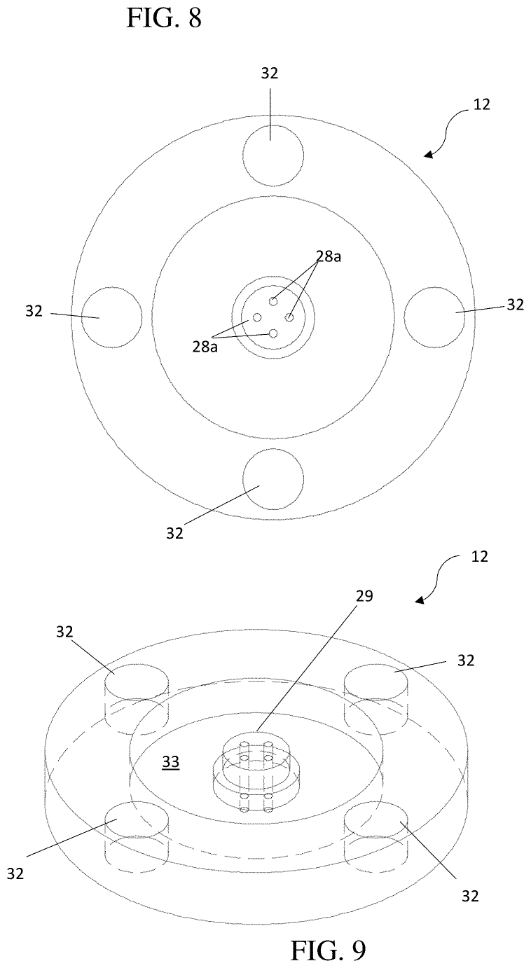

In the present exemplary embodiment, rotor 12 includes body 26 that has a disc shape. As best shown in FIGS. 6-9, the rotor body 26 includes a front face 30a that is substantially flat and outwardly facing and a back face 30b that includes cavities 32 positioned further out in the radial direction from the axis of rotation and are equally spaced apart. Two sets of through holes 28a are disposed within central portion 29 (FIG. 9) of the rotor body 26, symmetrically to the central axis of rotation “A” and located proximally thereto. A channel 33 is provided in the back face 30b of the rotor body 26 that receives a ring 37 extending outwardly from the stator 16.

Magnets 14 are disposed within properly shaped and sized cavities 32 of the rotor body 26. The magnets 14 may be neodymium, or other suitable magnets for example iron, ceramic, or alnico, provided that the magnetic field lines are substantially perpendicular to the face 30b of the rotor body 26. Magnets 14 are supported on the rotor 12 such that the lines of the magnetic field are substantially perpendicular to the faces 30a, b of the rotor body 26 in order that the magnetic flux projects mainly in the axial direction “A” of the rotor 12. The magnets are also positioned so that successive magnets have poles oriented in opposite directions. In order to increase the magnetic flux through the coil, a magnetic material, such as iron, may be added to the back face 30b opposite the stator, added inside the coils themselves, or to the back of the stator opposite the rotor. The rotor body 26 is made of a material that is sufficiently dense, such as for example metal (for example aluminum), plastic, or other suitable material so that the inertia of the rotor can overcome the friction from the bearing.

Bearing 34 connects the rotor 12 and stator 16. Bearing 34 allows the rotor to rotate while being constrained from translation in any direction because it is secured by the stationary structure 15. In the present embodiment, the bearing 34 is a ball bearing and the rotor body 26 is machined to attach to the inner race 36 of the bearing 34, while the stator 16 attaches to the outer race 38 of the bearing 34. Alternatively, the bearing utilized may be any type with relatively low friction and capable of high speeds (3000 rpm+), including but not limited to a roller, ball thrust, roller thrust, tapered roller, or magnetic bearing, made of any metal, ceramic, glass, or plastic material, as would be known to those of skill in the art. A friction press-fit keeps the components attached to the bearing 34, but in some embodiments a locking arrangement can also be utilized to maintain attachment, as would be known to those of skill in the art.

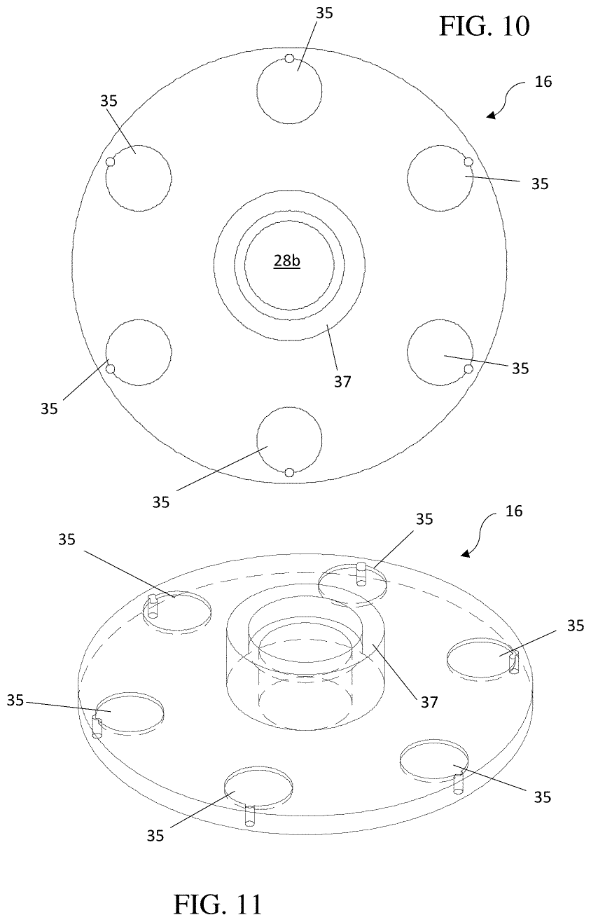

Referring now to FIGS. 6-7 and 10-11, stator 16 includes ring 37 bounding a larger through hole 28b for receiving the central portion 29 and the braided fiber string, or other material with the strength to support the rotor 12 as the filament 20 is wound and unwound, as would be known to those of skill in the art. The stator 16 further includes a plurality of coils or windings 18 made of a conductive metal wire, such as copper, with an outer coating of insulating material. The windings may be any of a variety of windings including, but not limited to, wild, helical, or orthocyclic, as would be known to those of skill in the art. The windings 18 are supported by the body of the stator within properly shaped and sized openings 35 in the present embodiment. The purpose of the plurality of windings 18 is to collect magnetic flux coming out of the magnets 14 in the rotor 12. As a result, the face 19 of windings are substantially parallel to the face 13 of the magnets 14 (i.e., perpendicular to the magnetic field lines) and in close enough proximity to the magnets 14 so they experience a change in flux as the magnets 14 rotate past the windings 18. In the present exemplary embodiment, there are six such windings 18, each with 100 turns, made of 24 AWG Magnet wire. Alternatively, any number of windings, turns and conductive wire may be utilized in order to achieve magnetic flux.

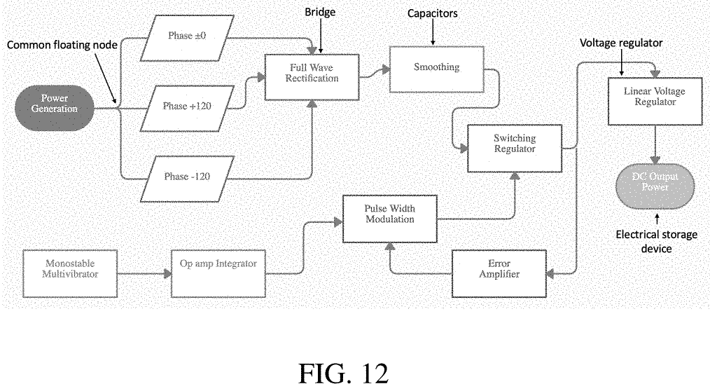

The stator 16 also includes a circuit that connects the windings 18 (the source of the voltage) to an electricity storage unit as shown in FIG. 12. In one exemplary embodiment, one terminal of the windings is connected to a common floating node (making a wye-connected system), and the other terminal of the windings go to a bridge, where the alternating current is rectified. The voltage is made steadier through an operation cycle with the use of capacitors, and the voltage is precisely controlled with a voltage regulator prior to entering an electrical storage device 17 so that electrical current can be used to charge a consumer electronic at the user's convenience. The energy storage device 17 may be a battery, for example a lithium-ion battery, lithium-ion polymer battery, lead-acid battery, Nickel-cadmium battery, Nickel-metal hydride battery, or a capacitor or supercapacitor or hydrogen fuel cell, or any other energy storage device as would be known to those of skill in the art.

The voltage is induced during use by causing relative rotation between the stator 16 and the rotor 12 to create the electrical current that is then stored in the electricity storage unit, such as a battery. In order to ensure that relative motion is induced during use, the stator 16 is part of stationary structure 15 and may be supported on a mounting member 39 that is secured to a stationary support 42, for example a table, in one embodiment. The mounting member 39 includes a base 40a having a through hole 40b for receipt of the filament therethrough and at least one fastener 40c securable to the stationary support 42. The stationary structure 15 prevents the stator from moving in time with the rotor, thus allowing for relative rotation between the stator 16 and the rotor 12.

In use, the rotation of the rotor 12 is created by use of the length of filament 20 that has been inserted through the holes of the rotor and stator 28a, b. Namely, the rotation is created by winding and then unwinding the length of filament 20 through translational motion of the string in order to induce rotation of the rotor 12 through cyclic translational forces applied by the user on either end of the length of filament 20 in the manner done with the traditional button spinner toy (FIG. 1) as described in greater detail below. In order to further facilitate the winding and unwinding of the length of filament 20, a pulley system may be operatively connected to the filament 20 to allow the input motion to operate over a larger distance and at a mechanical advantage, i.e., with a reduced input force. In addition, one end of the filament 20 may be anchored (unable to translate in any direction) to a fixed point, spring, or slide, while the other end is still adapted for pulling.

The electromagnetic induction generator 10 produces voltage and ultimately power from mechanical motion (namely the angular velocity) of the spinning rotor. The formulas that follow explain how the electromagnetic induction generator 10 produces electricity. The derivation begins by considering a single stationary coil (mounted to the stator) with a set of Nm magnets (mounted to the rotor) moving past it in a circular motion. Assuming there is an even number of magnets and successive magnets have poles oriented in opposite directions, pointing directly towards or directly opposite of the face of the coil, each successive magnet reverses the direction of magnetic flux passing through the coil. By Faraday's law, the voltage induced in the coil is:

$$V ( t ) = - \frac{d {Φ}_{T}}{dt}$$

Here Φ_{T} is the total flux through the coil at any instant. Assuming all N turns in the coil receive the same flux and drop the sign, the equation becomes:

$$V ( t ) = N \frac{d Φ}{dt}$$

Here Φ is the flux per turn. Recognizing that the magnetic flux through the coil is dependent on the angle of rotation of the magnet assembly and that the angle of rotation is a function of time, by the chain rule:

$${V ( t ) = N \frac{d Φ}{d θ} \frac{d θ}{dt} = N ω ( t ) \frac{d Φ}{d θ} \vert}_{θ ( t )}$$

In this equation Θ(t) is the angle of rotation of the magnet assembly. The flux Θ oscillates between a maximum of AB, when one pole of the magnet is aligned with the central axis of the coil, and −AB, when the other pole of the magnet is aligned with the central axis of the coil, where A is cross-sectional area of the coil and B is the average magnetic flux density experienced by a turn in the coil. For simplicity, we assume that Φ=AB when the coil is aligned with one of the magnets at θ=0. Further rotation gets the disc back to this defined starting condition, and thus the periodicity of the flux is

$$\frac{4 π}{N m} .$$

The magnetic flux through the coils does not change perfectly sinusoidally with respect to the angle about which the magnet assembly has rotated. However, we make this assumption to simplify the formula. Considering that the magnetic flux has a period of

$$\frac{4 π}{N m}$$

radians, then the flux as a function of angle is:

$$Φ ( θ ) = AB cos ( \frac{{N}_{m}}{2} θ ) .$$

Taking the derivative of the flux function with respect to (and again ignoring the sign) results in:

$$\frac{d Φ}{d θ} = \frac{{N}_{m}}{2} AB sin ( \frac{{N}_{m}}{2} θ ) .$$

Then the voltage equation becomes:

$$V ( t ) = {NABN}_{m} / 2 * ω ( t ) * sin ( \frac{{N}_{m}}{2} θ ( t ) ) .$$

The angle of rotation of the magnet assembly is related to the angular velocity by

$$θ ( t ) {{\int }_{0}}^{t} ω ( t ) dt .$$

Thus, the voltage equation becomes:

$$V ( t ) = {NABN}_{m} / 2 * ω ( t ) * sin ( \frac{{N}_{m}}{2} [ {{\int }_{0}}^{t} ω ( t ) dt ] )$$

Assuming that the angular velocity is changing slowly through time, which is logical assumption considering the goal is to couple the electrical and mechanical behavior to simulate the entire system through time (as opposed to current in any single coil at a moment in time). If we consider that there are 2 coils per phase, N_{C}, that receive the same amount of flux at any moment in time, then the voltage in that particular phase is:

V(t)=N_{C}NABNₘπω(t)/60

Where ω(t) is in units of revolutions per minute (RPM) rather than radians per second. Continuing with the assumption that the three-phase system is made of six coils (three pairs) and four magnets, with the opposite two coils wired in series, the peak induced voltage in the coils is doubled. Using 50 turns per coil, a coil cross-sectional area of 1.13e-3 m², a B field felt by the coils of 0.8 Tesla, 4 magnets, 6 coil windings, and a peak angular velocity of 10,000 RPM, the peak voltage is 189.2 volts (peak voltage=2*50*1.13e-3*0.8*4*3.14*10000/60).

The output of this pair of coils is one of three such outputs out of phase with each other by 120 degrees. These phases can be combined into a wye connection with a floating common node to a full wave three phase rectifier and the peak voltage coming out of the bridge is larger by a factor of the square root of 3. The DC output voltage will be about 90% of the peak voltage or 1.73*0.9*189.2=294.6 volts. Theoretically and with the stated parameters substituted in, this is the peak voltage output from the device.

As the angular velocity of the disc changes (dropping all the way to 0 RPM, from the assumed 10,000 RPM in the above calculation), the voltage output varies as well. Capacitors included in the circuitry will smooth out this highly time-dependent voltage output, making a steady voltage that will go into a switching regulator that drops the voltage down so that it can be accepted into an energy storage device 17. Power generation equals voltage times current; thus, the current is the other factor that determines the power output. The current is controlled by the battery, circuit components, and resistance in the circuitry.

A balance must be maintained such that enough power is generated but enough energy remains for the rotor to rewind. As the coil and magnet configuration generates electricity through induction, they pull power away from the electromagnetic induction generator 10 itself. The device, namely the circuit and battery, need to not draw so much energy from the disc that it does not have enough inertia to rewind the string (in the winding phase) and allow for its characteristic cyclic nature. The following formulas are used to determine the amount of power, voltage, and current that can be draws from the electromagnetic induction generator 10 while leaving enough energy to rewind:

dU_{MR}/dt=T_{CORD}ω−P_{ELECT}−K₁ω³−K₂ω

P_{ELECT}=V_{GEN}I_{SW}≈P_{CHG}

where U_{MR} is the instantaneous kinetic energy of the rotor with the magnets, T_{CORD} is the torque exerted by the string loop, P_{ELECT} is the power drawn from the generator as it generates electrical power, V_{GEN} is the voltage of the generator, I_{SW} is the current drawn by the top-level switching regulator, P_{CHG} is the power going into the battery charger, K₂ is a constant to account for friction forces in the bearing assembly, and K₁ is a constant to account for losses due to air drag.

During use, the frequency with which the translational motion at the ends of the strings is applied and the force associated with the translation motion are two factors that enable the user (or the environment) to control the power production potential of the electromagnetic induction generator 10.

Use of the device 10 will now be described with reference to FIGS. 2A-2B. The filament 20, for example a string, fishing line, wire, etc. begins unwound (FIG. 2A) and preloaded by winding the filament upon itself and reducing the length of the filament, i.e., the winding phase (FIG. 2B). The winding can be achieved by the user by grasping either end 24a, 24b of the filament 20 and moving the filament in a circular motion. Although the user may grip the ends 24a, 24b of the filament 20 with their hands, it is anticipated that any portion of the user's body may be utilized to pull the opposing ends 24a, 24b to move them in a circular motion. After preloading the user continues to grasp the filament 20 at either end 24a, 24b and pulls the ends of the filaments in opposing directions in order to induce unwinding of the filament, i.e., the unwinding phase. The outward force on the filament 20 by the user causes the previously twisted filament to unwind and lengthen, which makes the disc, i.e., rotor 12, accelerate. For optimal operation, once the filament 20 is unwound, the user should stop applying a force at the ends of the filament loop/handle 21 and allow their hands to move towards one another as the inertia of the disc causes the filament loop to rewind. When the input force drops to zero and the inertia of the rotor 12 causes the filament 20 to rewind on itself (providing stored energy in the same fashion that the preloading did), this is considered the secondary winding phase. The filament 20 twists linearly and can then go onto form packed supercoiled structures, where the twisted filament continues to twist around itself and the filament loop becomes thicker and shorter, if enough input energy was provided in the previous unwinding phase. The end of the winding period is marked by a momentary standstill of the rotor 12. The input force can then be reapplied, unwinding the filament 20 again.

The induction electricity generator disclosed herein is powered by cyclic translational motions, which act on the ends of a loop of filament. The generator is capable of high power output that is, high energy production in a short time, that surpasses other electricity generators currently on the market, which derive their input energy from human effort or other renewable energy sources. Due to the high angular velocity of the rotor, and the light weight of the device, it has the capability to produce approximately 210 Watts of power. While power production level does not compare to that of large combustion-based energy production plants, this power output is approximately 7 times greater than the maximum for a conventional hand-crank generator, and approximately 70 times greater than the maximum for conventional photovoltaic panel of comparable mass.

As will be appreciated, the device disclosed herein includes few parts, is modular and easily transported because of its small footprint and low weight. In addition, the device can be configured to harness its cyclic translational input energy from an array of active and ambient sources, including but not limited to, human hands and feet, ocean waves, river currents, and wind, or any other potential source of cyclic translational motion, by simply adapting the translational input for the winding. The easy operation allows the device to be operated by young and old alike, repeatedly without strain on the user. This combination means that the device can be readily and reliably used by people who are permanently or temporarily off-grid to generate and store electricity, which can then be used to charge an array of increasingly important electronic devices.

Having thus described several aspects of at least one example, it is to be appreciated that various alterations, modifications, and improvements will readily occur to those skilled in the art, without departing from the spirit and scope of the invention as defined by the appended claims. Therefore, the claims are not to be limited to the specific examples depicted herein. For instance, examples and embodiments disclosed herein may also be used in other contexts. Furthermore, various modifications and rearrangements of the parts may be made without departing from the spirit and scope of the underlying inventive concept. By way of example, the geometric configurations disclosed herein of the stator and rotor along with their sizes and number may be altered, as may the material selection for the components. Such alterations, modifications, and improvements are intended to be part of this disclosure and are intended to be within the scope of the examples discussed herein. Thus, the details of these components as set forth in the above-described examples, should not limit the scope of the claims.

Further, the purpose of the Abstract is to enable the U. S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to be limiting on the claims in any way.

What is claimed:

1. An electromagnetic electricity generator comprising:
a rotor including a body with a front face and an opposing back face, two or more through holes disposed through the body extending from the front face to the back face;
at least two magnets supported by the body, each including an outwardly facing surface;
a stator including a body and a plurality of windings supported on the stator body, the windings positioned substantially parallel to the outwardly facing surface of the at least two magnets, and further comprising conductive metal and a through hole;
a bearing connecting the rotor and stator and constructed and arranged to allow rotation of the rotor relative to the stator;
a filament including a first end and a second end, the filament extending through the at least two or more through holes, the first end and second end constructed and arranged to be pulled in opposing directions by an input force, and having a first length in an unwound position and a shorter, second length in a wound position; and
wherein during use the filament is rotated to wind the filament upon itself such that the length of the filament is shortened and thereafter the first and second ends are pulled in opposing directions to induce unwinding of the filament, the outward force on the filament causing the previously twisted filament to unwind and lengthen, inducing the rotor to accelerate as it rotates relative to the stator causing the magnets to pass by the windings creating a changing magnetic field that induces voltage.

2. The generator of claim 1, wherein the induced voltage charges an energy storage device.

3. The generator of claim 2, wherein said energy storage device is a lithium-ion battery, lithium-ion polymer battery, lead-acid battery, Nickel-cadmium battery, Nickel-metal hydride battery, capacitor or supercapacitor or hydrogen fuel cell.

4. The generator of claim 1, wherein the stator includes a through hole configured and sized to receive the portion of the rotor including the two or more through holes.

5. The generator of claim 1, wherein the first and second ends of the filament include at least one of a loop or a handle that is constructed and arranged to be gripped by a user such that the input force is created by the user physically pulling on each of the first and second ends.

6. The generator of claim 1, further comprising a mounting member constructed and arranged to secure the stator in order to deter rotation of the stator during use and constrain translational movement.

7. The generator of claim 6, wherein the mounting member includes a base having a through hole for receipt of the filament therethrough and at least one fastener securable to a substrate.

8. The generator of claim 7, wherein the at least one fastener is a pair of legs and the substrate is a table.

9. The generator of claim 1, wherein the at least two through holes are disposed symmetric and proximal to an axis of rotation of the rotor body.

10. The generator of claim 1, wherein the at least two magnets are positioned so that magnetic field lines from the at the at least two magnets are substantially perpendicular with the back face of the rotor body.

11. The generator of claim 1, wherein the at least two magnets are positioned so that the magnetic field lines point in the axial direction of the rotor body.

12. The generator of claim 1, wherein the at least two magnets are positioned so that the magnetic field lines point in the radial direction of the rotor body.

13. The generator of claim 1, wherein the at least two magnets comprise at least one of iron, ceramic, alnico, or neodymium.

14. The generator of claim 1, wherein the filament comprises two filaments tied in independent loops that are positioned one on either side of the rotor body, each loop being attached by two attachment points either side of the rotor body.

15. The generator of claim 14, wherein the filaments are made of material selected from the group consisting of metal, plastic, carbon, and organic material, and is braided or single stranded.

16. The generator of claim 1, wherein the bearing is selected from the group consisting of a ball, roller, ball thrust, roller thrust, tapered roller, or magnetic bearing.

17. The generator of claim 1, wherein said windings are coated in an electrically-insulating material, the windings being selected from the group consisting of a wild, helical, or orthocyclic windings.

18. An electromagnetic electricity generator comprising:
a rotor including a body with a front face and an opposing back face, two or more through holes disposed through the body extending from the front face to the back face and disposed symmetric to an axis of rotation of the body;
at least two magnets supported by the body, each including an outwardly facing surface positioned so that magnetic field lines are substantially perpendicular with the back face of the rotor body;
a stator including a body and a plurality of windings supported on the stator body, the windings positioned substantially parallel to the outwardly facing surface of the at least two magnets, and further comprising conductive metal, the stator further including a through hole configured and sized to receive the portion of the rotor body including the two or more through holes;
a bearing connecting the rotor and stator and constructed and arranged to allow rotation of the rotor relative to the stator;
a mounting member constructed and arranged to secure the stator to deter rotation of the stator during use and constrain translational movement;
a filament including a first end and a second end, the filament extending through the at least two or more through holes of the rotor and the through hole of the stator, the first end and second end constructed and arranged to be pulled in opposing directions by an input force, and having a first length in an unwound position and a shorter, second length in a wound position; and
wherein during use the filament is rotated to wind the filament upon itself such that the length of the filament is shortened and thereafter the first and second ends are pulled in opposing directions to induce unwinding of the filament causing the rotor to accelerate and rotate relative to the stator causing the magnets to pass by the windings creating a changing magnetic field that induces voltage.

19. The generator of claim 18, wherein the at least two magnets are positioned so that the magnetic field lines point in the radial direction of the rotor body.

20. A method for inducing voltage comprising:
providing an electromagnetic energy generator including
a) a rotor configured for rotation and supporting at least two magnets;
b) a stator mounted to a stationary mounting member and including a plurality of conductive windings positioned substantially parallel to an outwardly facing surface of the at least two magnets;
c) a bearing connecting the rotor and stator and constructed and arranged to allow rotation of the rotor relative to the stator;
d) a filament including a first end and a second end having a length, the filament extending through the rotor, stator and mounting member;
winding the filament upon itself such that the length of the filament is shortened;
applying a pulling force to at least one of the first end and second end of the filament to induce unwinding of the filament causing the rotor to accelerate and rotate relative to the stator; and
wherein rotation of the rotor causes the magnets to pass by the windings creating a changing magnetic field that induces voltage.
